(19) United States
(12) Patent Application Publication
(10) Pub. No.: US 2015/0160747 A1
(43) Pub. Date: Jun. 11, 2015

(54) TOUCH PANEL, DISPLAY DEVICE INCLUDING TOUCH PANEL, AND METHOD OF MANUFACTURING TOUCH PANEL

(71) Applicant: Sharp Kabushiki Kaisha, Osaka-shi, Osaka (JP)

(72) Inventors: Yasuhiro Kohara, Osaka-shi (JP); Hidekazu Ohshima, Osaka-shi (JP)

(21) Appl. No.: 14/407,128

(22) PCT Filed: Jun. 18, 2013
(86) PCT No.: PCT/JP2013/066755

§ 371 Date: Dec. 11, 2014

(30) Foreign Application Priority Data
Jun. 27, 2012 (JP) 2012-144269

(51) Int. Cl. G06F 3/041

(52) U.S. Cl. CPC G06F 3/041; G06F 2203/04103

(57) ABSTRACT

A touch panel includes: a substrate; first electrodes; a first light-shielding layer element; second electrodes; second light-shielding layer elements; first relay electrodes; and metal lines. The substrate includes a touch surface. The first light-shielding layer element is provided on the substrate and located outside the first electrodes measured in a predetermined direction. The second electrodes are provided on the substrate, each second electrode located between two first electrodes arranged in the predetermined direction. Each of the second light-shielding layer elements is provided between two first electrodes and covers one of the second electrodes. Each of the first relay electrodes is provided above one of the second light-shielding layer elements and electrically connects two first electrodes. The metal lines are provided on the first light-shielding layer element and connected to external circuitry. The first and second light-shielding layer elements are organic films containing a light-shielding component.

### TECHNICAL FIELD

The present invention relates to a touch panel, a display device including a touch panel, and a method of manufacturing a touch panel.

### BACKGROUND ART

Touch panels are known as input devices. A touch panel detects the location of a touch by a finger, pen or the like.

JP 2009-301767 A discloses a capacitive coupling touch panel device. This touch panel device includes a touch panel and an LCD panel unit. The touch panel includes a transparent substrate. The transparent substrate can be depressed by a finger or the like. A light-shielding layer is provided on the outer peripheral portions of the lower surface of the transparent substrate. The light-shielding layer blocks light from the LCD panel unit. On the lower surface of the transparent substrate are provided an overcoat layer, a transparent conductive layer and an insulating layer, deposited in this order. The overcoat layer covers the light-shielding layer. The transparent conductive layer is shaped in a predetermined pattern.

### DISCLOSURE OF THE INVENTION

The light-shielding layer disclosed in the above publication may be a metal film such as of chromium, for example, and is conductive. As such, an overcoat layer covering the light-shielding layer is necessary to prevent the light-shielding layer from adversely affecting the determination of a touch location.

If a projected capacitive coupling touch panel is to provide increased precision in multi-point detection, the number of transparent electrodes must be increased. For example, a touch panel may include a plurality of insular electrodes arranged in a matrix. Such a touch panel has first relay electrodes located in the same layer as the insular electrodes, each first relay electrode electrically connecting two adjacent insular electrodes disposed in a first direction. Second relay electrodes are provided in a layer different from that for the insular electrodes, each second relay electrode electrically connecting two adjacent insular electrodes disposed in a second direction that crosses the first direction. An insulating layer is provided between the layer with the insular electrodes and the layer with the second relay electrodes.

As is apparent therefrom, if electrodes are provided in different layers, an interlayer insulating film is necessary. Accordingly, if a touch panel including light-shielding layer elements made of metal includes electrodes in different layers, the touch panel is manufactured in an increased number of steps.

An object of the present invention is to reduce the number of steps for manufacturing a touch panel including light-shielding layer elements and having electrodes in different layers.

A touch panel according to an embodiment of the present invention includes: a substrate; first electrodes; a first light-shielding layer element; second electrodes; second light-shielding layer elements; first relay electrodes; and a metal line. The first electrodes are provided in a series on the substrate and arranged in a predetermined direction. The first light-shielding layer element is provided on the substrate and located outside the series of first electrodes measured in the predetermined direction. The second electrodes are provided on the substrate, each second electrode located between two first electrodes arranged in the predetermined direction. Each of the second light-shielding layer elements is provided between two first electrodes arranged in the predetermined direction and covers one of the second electrodes. Each of the first relay electrodes is provided above one of the second light-shielding layer elements and electrically connects two first electrodes arranged in the predetermined direction. The metal line is provided on the first light-shielding layer element and connected to external circuitry. The metal line is connected with the one of the series of first electrodes arranged in the predetermined direction that is located at one end of this series. The side of the substrate that is opposite the side on which the first light-shielding layer element is provided forms a touch surface. The first light-shielding layer element and the second light-shielding layer elements are organic films containing a light-shielding component.

The touch panel according to an embodiment of the present invention may be manufactured in a reduced number of steps.

### BRIEF DESCRIPTION OF THE DRAWINGS

FIG. 1 is a plan view of a touch panel according to a first embodiment of the present invention.

FIG. 2 is a cross-sectional view of the panel taken along II-II in FIG. 1.

FIG. 3A is a cross-sectional view of the touch panel of the first embodiment illustrating one of the steps for manufacturing the panel, where a transparent conductive film has been formed on the substrate.

FIG. 3B is a cross-sectional view of the touch panel of the first embodiment illustrating one of the steps for manufacturing the panel, where a plurality of transparent electrodes have been formed on the substrate.

FIG. 3C is a cross-sectional view of the touch panel of the first embodiment illustrating one of the steps for manufacturing the panel, where a resist has been formed.

FIG. 3D is a cross-sectional view of the touch panel of the first embodiment illustrating one of the steps for manufacturing the panel, where a plurality of second light-shielding layer elements and a first light-shielding layer element have been formed on the substrate, in addition to the transparent electrodes.

FIG. 3E is a cross-sectional view of the touch panel of the first embodiment illustrating one of the steps for manufacturing the panel, where a metal film has been formed.

FIG. 3F is a cross-sectional view of the touch panel of the first embodiment illustrating one of the steps for manufacturing the panel, where a plurality of lead lines have been formed.

FIG. 3G is a cross-sectional view of the touch panel of the first embodiment illustrating one of the steps for manufacturing the panel, where a transparent conductive film has been formed.

FIG. 3H is a cross-sectional view of the touch panel of the first embodiment illustrating one of the steps for manufacturing the panel, where a plurality of first and second relay electrodes have been formed.

FIG. 4 is a schematic view of a display device including the touch panel according to the first embodiment.

FIG. 5 is a cross-sectional view of the display device of FIG. 4 illustrating the relationship between the touch panel and liquid crystal panel.

FIG. 6 is a cross-sectional view of the touch panel of Example Application 1 of the first embodiment of the present invention.

FIG. 7A is a cross-sectional view of the touch panel of Example Application 1 of the first embodiment illustrating one of the steps for manufacturing the panel, where a metal film has been formed.

FIG. 7B is a cross-sectional view of the touch panel of Example Application 1 of the first embodiment illustrating one of the steps for manufacturing the panel, where a plurality of lines and first relay electrodes have been formed.

FIG. 7C is a cross-sectional view of the touch panel of Example Application 1 of the first embodiment illustrating one of the steps for manufacturing the panel, where a transparent conductive film has been formed.

FIG. 7D is a cross-sectional view of the touch panel of Example Application 1 of the first embodiment illustrating one of the steps for manufacturing the panel, where second relay electrodes and electrode protection films have been formed.

FIG. 8 is a cross-sectional view of the touch panel of Example Application 2 of the first embodiment of the present invention.

FIG. 9 is a cross-sectional view of a touch panel according to a second embodiment of the present invention.

FIG. 10A is a cross-sectional view of the touch panel of the second embodiment illustrating one of the steps for manufacturing the panel, where a plurality of transparent electrodes and second light-shielding layer elements and a first light-shielding layer element have been formed on the substrate and contact holes have been formed in the first light-shielding layer element.

FIG. 10B is a cross-sectional view of the touch panel of the second embodiment illustrating one of the steps for manufacturing the panel, where a metal film has been formed.

FIG. 10C is a cross-sectional view of the touch panel of the second embodiment illustrating one of the steps for manufacturing the panel, where a plurality of lead lines and first relay electrodes have been formed.

FIG. 11 is a cross-sectional view of a touch panel of an example application of the second embodiment of the present invention.

FIG. 12A is a cross-sectional view of the touch panel of the example application of the second embodiment illustrating one of the steps for manufacturing the panel, where a plurality of lead lines have been formed.

FIG. 12B is a cross-sectional view of the touch panel of the example application of the second embodiment illustrating one of the steps for manufacturing the panel, where a transparent conductive film has been formed.

FIG. 12C is cross-sectional view of the touch panel of the example application of the second embodiment illustrating one of the steps for manufacturing the panel, where a plurality of first relay electrodes and line protection films have been formed.

FIG. 13 is a cross-sectional view of a touch panel according to a third embodiment of the present invention.

FIG. 14A is a cross-sectional view of the touch panel of the third embodiment illustrating one of the steps for manufacturing the panel, where a plurality of transparent electrodes and second light-shielding layer elements and a first light-shielding layer element have been formed on the substrate.

FIG. 14B is a cross-sectional view of the touch panel of the third embodiment illustrating one of the steps for manufacturing the panel, where an insulating film has been formed.

FIG. 14C is a cross-sectional view of the touch panel of the third embodiment illustrating one of the steps for manufacturing the panel, where a first protection film and a plurality of second protection films have been formed.

FIG. 14D is a cross-sectional view of the touch panel of the third embodiment illustrating one of the steps for manufacturing the panel, where a metal film has been formed.

FIG. 14E is a cross-sectional view of the touch panel of the third embodiment illustrating one of the steps for manufacturing the panel, where a plurality of lines have been formed.

FIG. 14F is a cross-sectional view of the touch panel of the third embodiment illustrating one of the steps for manufacturing the panel, where a transparent conductive film has been formed.

FIG. 14G is a cross-sectional view of the touch panel of the third embodiment illustrating one of the steps for manufacturing the panel, where a plurality of first relay electrodes and second relay electrodes have been formed.

### EMBODIMENTS FOR CARRYING OUT THE INVENTION

A touch panel according to an embodiment of the present invention includes: a substrate; first electrodes; a first light-shielding layer element; second electrodes; second light-shielding layer elements; first relay electrodes; and a metal line. The first electrodes are provided in a series on the substrate and arranged in a predetermined direction. The first light-shielding layer element is provided on the substrate and located outside the series of first electrodes measured in the predetermined direction. The second electrodes are provided on the substrate, each second electrode located between two first electrodes arranged in the predetermined direction. Each of the second light-shielding layer elements is provided between two first electrodes arranged in the predetermined direction and covers one of the second electrodes. Each of the first relay electrodes is provided above one of the second light-shielding layer elements and electrically connects two first electrodes arranged in the predetermined direction. The metal line is provided on the first light-shielding layer element and connected to external circuitry. The metal line is connected with the one of the series of first electrodes arranged in the predetermined direction that is located at one end of this series. The side of the substrate that is opposite the side on which the first light-shielding layer element is provided forms a touch surface. The first light-shielding layer element and the second light-shielding layer elements are organic films containing a light-shielding component (first mode of a touch panel).

In the first mode, the metal lines are hidden under the first light-shielding layer element provided on the substrate which includes the touch surface. This results in a thinner touch panel than in implementations where a cover element is positioned closer to the viewer than the touch panel is and a light-shielding layer element is formed in this cover element.

In the first mode, the second light-shielding layer elements serve as interlayer insulating films positioned between the layer having the first electrodes and the layer having the first relay electrodes. The second light-shielding layer elements are formed of the same material as the first light-shielding layer element. As such, the first and second light-shielding layer elements may be formed at the same time. This will reduce the number of steps for manufacturing a touch panel.

In a second mode, starting from the first mode, the first light-shielding layer element covers the one of the series of first electrodes arranged in the predetermined direction that is located at one end of this series. The first light-shielding layer element has a contact hole overlying said one of the first electrodes in a plan view of the substrate. The metal line contacts said one of the first electrodes via the contact hole.

The second mode realizes an arrangement where the metal lines are electrically connected with the associated first electrodes via the respective contact holes.

In a third mode, starting from the second mode, a line protection film covering the metal line is further included. The line protection film is made of the same material as the first relay electrodes.

In the third mode, the metal lines are less likely to be damaged when the first relay electrodes are formed, for example.

In a fourth mode, starting from the first mode, a second relay electrode is further included. The second relay electrode covers the one of the series of first electrodes arranged in the predetermined direction that is located at one end of this series, and the metal line.

The fourth mode realizes an arrangement where the metal lines are electrically connected with the associated first electrodes via the respective second relay electrodes.

In a fifth mode, starting from the fourth mode, a line protection film is further included. The line protection film is connected with the second relay electrode and covers the metal line.

In the fifth mode, the metal lines are less likely to be damaged when the second relay electrodes are formed, for example.

In a sixth mode, starting from the fifth mode, electrode protection films covering the respective first relay electrodes are further included. The first relay electrodes are made of the same material as the metal line. The electrode protection films are made of the same material as the second relay electrode.

In the sixth mode, not only the metal lines, but also the first relay electrodes are less likely to be damaged when the second relay electrodes are formed, for example.

In a seventh mode, starting from one of the first to sixth modes, a protection film covering the organic films is further included. In the seventh mode, the organic films may be prevented from being damaged by manufacturing steps following the formation of the organic films.

A display device according to an embodiment of the present invention includes the touch panel according to an embodiment of the present invention and a display panel for displaying an image. As the touch panel is manufactured in a reduced number of steps, the display device is manufactured in a reduced number of steps, as well.

A method of manufacturing a touch panel according to an embodiment of the present invention includes the following steps (a) to (e). Step (a) involves forming, on a substrate, a series of first electrodes arranged in a predetermined direction and second electrodes each disposed between two first electrodes arranged in the predetermined direction. Step (b) involves forming an organic film covering the series of first electrodes and the second electrodes. Steps (c) involves patterning the organic film to form a first light-shielding layer element located outside the series of first electrodes in the predetermined direction and second light-shielding layer elements each disposed between two first electrodes arranged in the predetermined direction and covering one of the second electrodes. Step (d) involves forming first relay electrodes each located above one of the second light-shielding layer elements and electrically connecting two first electrodes arranged in the predetermined direction. Step (e) involves forming, on the first light-shielding layer element, a metal line connected to external circuitry. In step (c), the first light-shielding layer element is formed to cover the one of the series of first electrodes arranged in the predetermined direction that is located at one end of this series and a contact hole is formed in the first light-shielding layer element to overlie said one of the first electrodes in a plan view of the substrate. In step (e), the metal line is located to overlie the contact hole in a plan view of the substrate (first mode of a method of manufacturing a touch panel).

In the first mode, a first light-shielding layer element is provided on the substrate which includes a touch surface. The metal lines are hidden under this first light-shielding layer element. This results in a thinner touch panel than in implementations where a cover element is positioned closer to the viewer than the touch panel is and a light-shielding layer element is formed in this cover element.

In the first mode, the first and second light-shielding layer elements may be formed at the same time. This will reduce the number of steps for manufacturing a touch panel.

In a second mode, starting from the first mode, step (d) forms the metal line. The second mode further reduces the number of steps for manufacturing a touch panel.

In a third mode, starting from the first mode, step (d) forms a line protection film covering the metal line. In the third mode, the metal lines are less likely to be damaged when the first relay electrodes are formed.

A method of manufacturing a touch panel according to an embodiment of the present invention includes the following steps (a) to (f). Step (a) involves forming, on a substrate, a series of first electrodes arranged in a predetermined direction and second electrodes each disposed between two first electrodes arranged in the predetermined direction. Step (b) involves forming an organic film covering the series of first electrodes and the second electrodes. Steps (c) involves patterning the organic film to form a first light-shielding layer element located outside the series of first electrodes in the predetermined direction and second light-shielding layer elements each disposed between two first electrodes arranged in the predetermined direction and covering one of the second electrodes. Step (d) involves forming, on the first light-shielding layer element, a metal line connected to external circuitry. Step (e) involves forming first relay electrodes each located above one of the second light-shielding layer elements and electrically connecting two first electrodes arranged in the predetermined direction. Step (f) involves forming a second relay electrode covering the one of the series of first electrodes arranged in the predetermined direction that is located at one end of this series, and the metal line (fourth mode of a method of manufacturing a touch panel).

In the fourth mode, a first light-shielding layer element is provided on the substrate which includes a touch surface. The metal lines are hidden under this first light-shielding layer element. This results in a thinner touch panel than in implementations where a cover element is positioned closer to the viewer than the touch panel is and a light-shielding layer element is formed in this cover element.

In the fourth mode, interlayer insulating films disposed between the layer having the first electrodes and the layer having the second electrodes, and protection insulating films covering the light-shielding layer elements are implemented using an insulating layer. That is, the interlayer insulating films and protection insulating films may be formed at the same time. This will reduce the number of steps for manufacturing a touch panel.

In a fifth mode, starting from the fourth mode, step (d) forms the first relay electrodes. The fifth mode further reduces the number of steps for manufacturing a touch panel.

In a sixth mode, starting from the fifth mode, step (f) forms a line protection film connected with the second relay electrode and covering the metal line, and electrode protection films covering the respective first relay electrodes. In the sixth mode, the metal lines and first relay electrodes are less likely to be damaged when the second relay electrodes are formed.

In a seventh mode, starting from the fourth mode, step (e) forms the second relay electrode. The seventh mode further reduces the number of steps for manufacturing a touch panel.

In an eighth mode, starting from the seventh mode, step (e) forms a line protection film connected with the second relay electrode and covering the metal line. In the eighth mode, the metal lines are less likely to be damaged when the second relay electrodes are formed.

In a ninth mode, starting from one of the first to eighth modes, the step of forming a first protection film covering the first light-shielding layer element and second protection films covering the respective second light-shielding layer elements is further included.

In the ninth mode, the first and second light-shielding layer elements may be prevented from being damaged by manufacturing steps following the formation of the first and second light-shielding layer elements.

Now, more specific embodiments of the present invention will be described with reference to the drawings. The same or corresponding components in the drawings are labeled with the same characters and their description will not be repeated. For ease of explanation, the drawings to which reference will be made hereinafter show simplified or schematic representation, or do not show some components. The size ratios of the components shown in the drawings do not necessarily represent the actual size ratios.

### First Embodiment

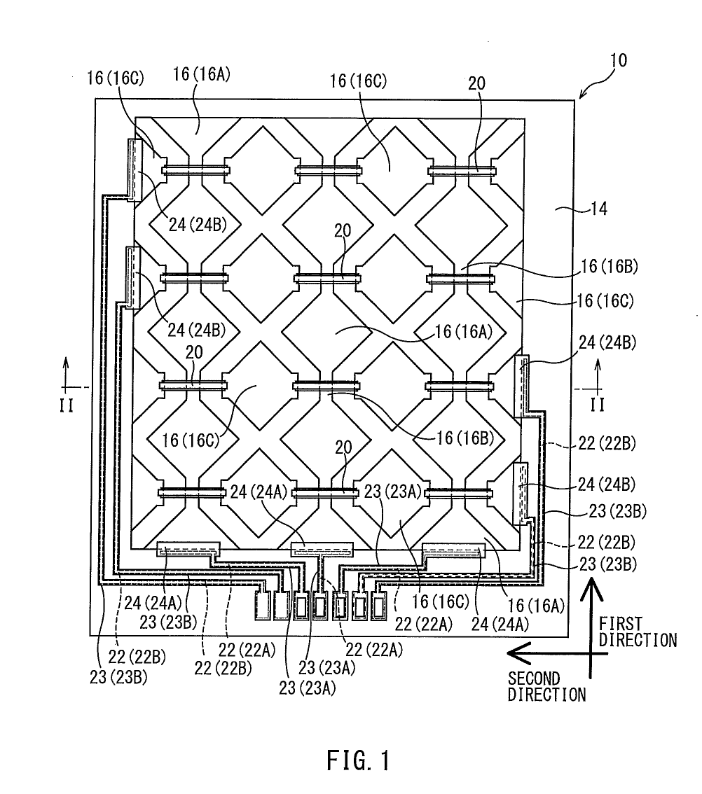

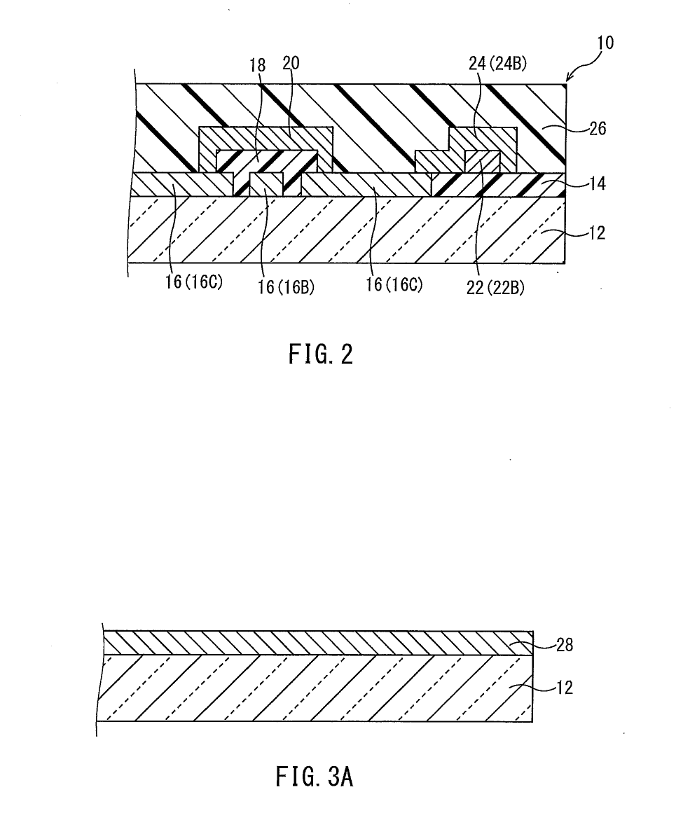

A touch panel 10 according to a first embodiment of the present invention will be described with reference to FIGS. 1 and 2. FIG. 1 is a plan view of the touch panel 10. FIG. 2 is a cross-sectional view of the panel taken along II-II in FIG. 1.

[Overall Construction of Touch Panel]

The touch panel 10 is a projected capacitive touch panel. The touch panel 10 includes a substrate 12, a first light-shielding layer element 14, transparent electrodes 16, second light-shielding layer elements 18, first relay electrodes 20, lead lines 22, second relay electrodes 24, and a protection layer 26.

The substrate 12 may be any transparent insulating substrate. The substrate 12 may be, for example, an alkali-free glass substrate, or an acrylic resin substrate.

The first light-shielding layer element 14 is provided in contact with a major surface of the substrate 12. In the present embodiment, the first light-shielding layer element 14 is in the shape of a picture frame in a plan view of the substrate 12. Although the outer edges of the first light-shielding layer element 14 is aligned with the outer edges of the substrate 12 in the present embodiment, this need not be the case. The first light-shielding layer element 14 may be any organic film containing a light-shielding component. The light-shielding component may be a titanium component or carbon black, for example. The organic film may be made of a photosensitive acrylic resin, for example.

A plurality of transparent electrodes 16 are provided in contact with the major surface of the substrate 12. The transparent electrodes 16 may be made from any transparent conductive film. The transparent electrodes 16 may be made of indium tin oxide (ITO), for example, which is preferably polycrystalline at least after patterning. This ensures the stability of the transparent electrodes 16 in manufacturing steps after the formation of the transparent electrodes 16.

The transparent electrodes 16 include first transparent electrodes 16A, second transparent electrodes 16B and third transparent electrodes 16C.

The first and second transparent electrodes 16A and 16B are alternately arranged in a first direction (i.e. top-to-bottom direction in FIG. 1). A plurality of columns of electrodes, that is, first and second transparent electrodes 16A and 16B (i.e. first series of electrodes) are arranged in a second direction (i.e. left-to-right direction in FIG. 1). In each first series of electrodes, the first and second transparent electrodes 16A and 16B are integrally formed.

The third transparent electrodes 16C are arranged in the first and second directions. Each of the second transparent electrodes 16B is located between two adjacent third transparent electrodes 16C disposed in the second direction. That is, in the present embodiment, the third transparent electrodes 16C correspond to the first electrodes, while the second transparent electrodes 16B correspond to the second electrodes.

Each second light-shielding layer element 18 is located between two adjacent third transparent electrodes 16C disposed in the second direction and covers the associated one of the second transparent electrodes 16B. The second light-shielding layer elements 18 are made of the same material as the first light-shielding layer element 14.

Each first relay electrode 20 is provided above the associated one of the second light-shielding layer elements 18. In a plan view of the substrate 12, the third transparent electrodes 16C and first relay electrodes 20 are alternately arranged in the second direction. A plurality of rows of electrodes, that is, third transparent electrodes 16C and first relay electrodes 20 (i.e. second series of electrodes) are arranged in the first direction. In each second series of electrodes, each of the first relay electrodes 20 electrically connects two adjacent third transparent electrodes 16C disposed in the second direction. In the present embodiment, each first relay electrode 20 electrically connects two adjacent third transparent electrodes 16C disposed in the second direction as one of the ends of the first relay electrode 20 disposed in the second direction contacts one of the third transparent electrodes 16C while the other one of the ends contacts the other one of the third transparent electrodes 16C.

The first relay electrodes 20 may be made from any conductive film. A conductive film may be, for example, a metal film, or a transparent film. A metal film includes at least one of aluminum, molybdenum and copper, for example. A transparent film may be, for example, made of indium tin oxide (ITO), which is preferably polycrystalline at least after patterning. This ensures the stability of the first relay electrodes 20 in manufacturing steps after the formation of the first relay electrodes 20. If the first relay electrodes 20 are made of metal, the first relay electrodes 20 have a relatively small resistance.

A plurality of lead lines 22 are formed on the first light-shielding layer element 14. The lead lines 22 are made of metal. The metal includes at least one of aluminum, molybdenum and copper, for example.

A plurality of second relay electrodes 24 are provided. The second relay electrodes 24 electrically connect the associated lead lines 22 with the associated transparent electrodes 20. Details thereof will be described below.

The lead lines 22 include lead lines 22A and lead lines 22B. The second relay electrodes 24 include second relay electrodes 24A and second relay electrodes 24B.

Each of the second relay electrodes 24A is provided to contact the one of a column of first transparent electrodes 16A forming a first electrode series that is located at one end of this column extending in the first direction, and one end of a lead line 22A. Thus, that first transparent electrode 16A is electrically connected with that lead line 22A via the second relay electrode 24A. The other end of the lead line 22A has a terminal to be connected to external circuitry.

Each lead line 22A is covered with a line protection film 23A extending from that first transparent electrode 16A which covers one end of the line. That is, the line protection films 23A are formed of the same material as the first transparent electrodes 16A.

Each of the second relay electrodes 24B is provided to contact the one of a row of third transparent electrodes 16C forming a second electrode series that is located at one end of this row extending in the second direction, and one end of a lead line 22B. Thus, that third transparent electrode 16C is electrically connected with that lead line 22B via the second relay electrode 24B. The other end of the lead line 22B has a terminal to be connected to external circuitry.

Each lead line 22B is covered with a line protection film 23B extending from that third transparent electrode 16C which covers one end of the line. That is, the line protection films 23B are formed of the same material as the third transparent electrodes 16C.

The protection layer 26 covers the first light-shielding layer element 14, transparent electrodes 16, lead lines 22, and second relay electrodes 24. The protection layer 26 may be any insulating layer. The protection layer 26 may be, for example, an acrylic resin film, a siloxane-based film, a polyimide-based film or a silicon-based inorganic film.

[Method of Manufacturing Touch Panel]

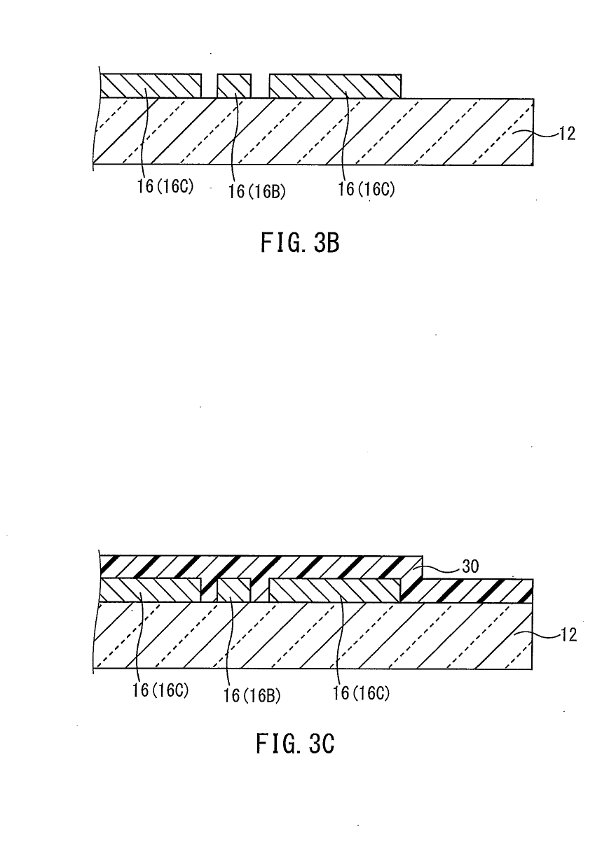

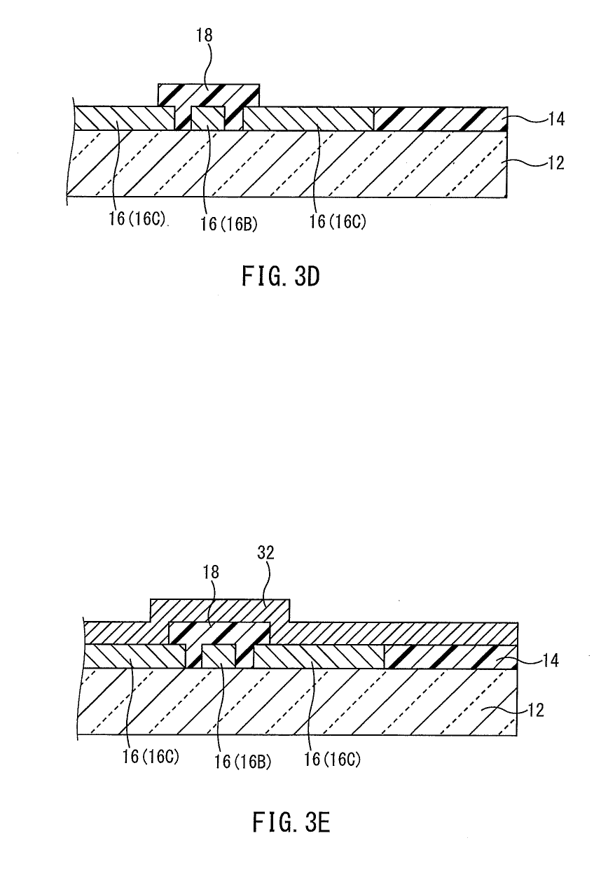

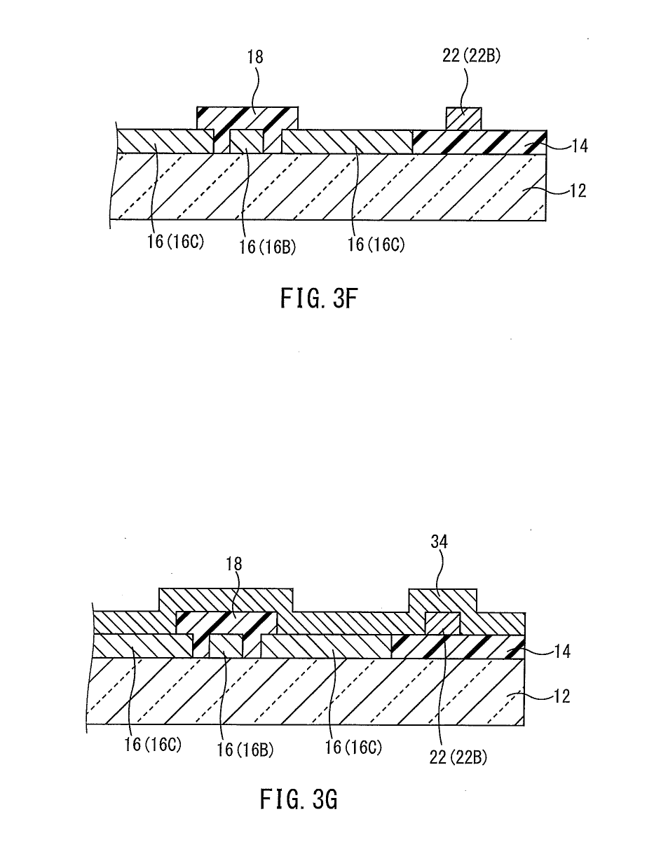

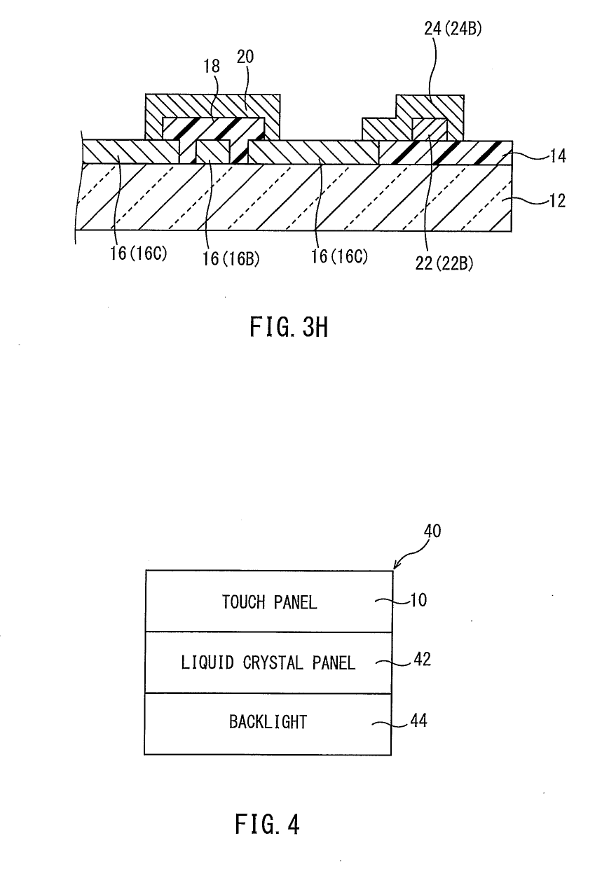

A method of manufacturing a touch panel 10 will described with reference to FIGS. 3A to 3H. Manufacture of a touch panel 10 is not limited to the following method.

The method of manufacturing a touch panel 10 includes the step of forming transparent electrodes 16, the step of forming a first light-shielding layer element 14 and second light-shielding layer elements 18, the step of forming lead lines 22, the step of forming first relay electrodes 20 and second relay electrodes 24, and the step of forming a protection layer 26.

[Step of Forming Transparent Electrodes]

First, as shown in FIG. 3A, a transparent conductive film 28 is formed to cover an entire major surface of a substrate 12. The transparent conductive film 28 may be formed by sputtering, for example.

Subsequently, the transparent conductive film 28 is photolithographically patterned. More specifically, first, a resist in a predetermined pattern is formed on the transparent conductive film 28. Then, the portions of the transparent conductive film 28 that are not covered with the resist are removed by wet etching. Thereafter, the resist is removed using a stripping agent. Thus, as shown in FIG. 3B, transparent electrodes 16 are formed to contact the surface of the substrate 12. The etchant used for wet etching may be, for example, ferric chloride or an oxalic acid-based etchant.

[Step of Forming First and Second Light-Shielding Layer Elements]

When the transparent electrodes 16 have been formed, a first light-shielding layer element 14 and second light-shielding layer elements 18 are formed. More specifically, first, as shown in FIG. 3C, a resist 30 is applied to cover the substrate 12 and the transparent electrodes 16. The resist 30 includes a light-shielding component such as a titanium compound, for example. That is, the resist 30 corresponds to the organic films containing a light-shielding component.

Subsequently, the resist 30 is patterned. More specifically, for example, a negative resist 30 is covered with a mask and is then exposed to light. Thereafter, the portions of the resist 30 that have not been exposed to light are removed using a developer. Thus, as shown in FIG. 3D, a first light-shielding layer element 14 and second light-shielding layer elements 18 are formed.

[Step of Forming Lead Lines]

When the first and second light-shielding layer elements 14 and 18 have been formed, lead lines 22 are formed. More specifically, first, as shown in FIG. 3E, a metal film 32 is formed. The metal film 32 may be formed by sputtering, for example.

Subsequently, the metal film 32 is photolithographically patterned. More specifically, first, a resist in a predetermined pattern is formed on the metal film 32. Then, the portions of the metal film 32 that are not covered with the resist are removed by wet etching. Thereafter, the resist is removed using a stripping agent. Thus, as shown in FIG. 3F, a plurality of lead lines 22 are formed to contact the surface of the first light-shielding layer element 14. The etchant used for wet etching may be, for example, one of phosphoric acid, nitric acid, hydrofluoric acid and hydrogen peroxide water, or a mixture containing one of them.

[Step of Forming First and Second Relay Electrodes]

When the lead lines 22 have been formed, first and second relay electrodes 20 and 24 are formed. More specifically, first, as shown in FIG. 3G, a transparent conductive film 34 is formed.

Subsequently, the transparent conductive film 34 is photolithographically patterned. More specifically, first, a resist in a predetermined pattern is formed on the transparent conductive film 34. Then, the portions of the transparent conductive film 34 that are not covered with the resist are removed by wet etching. Thereafter, the resist is removed using a stripping agent. Thus, as shown in FIG. 3H, first and second relay electrodes 20 and 24 are formed. Line protection films 23A cover the respective lead lines 22A, while line protection films 23B cover the respective lead lines 22B. The etchant used for wet etching may be, for example, ferric chloride or an oxalic acid-based etchant. The lead lines 22A and 22B may be prevented from being damaged during patterning of the transparent conductive film 34 as they are covered with the respective line protection films 23A and 23B.

[Step of Forming Protection Layer]

When the first and second relay electrodes 20 and 24 have been formed, a protection layer 26 is formed. If the protection layer 26 is to be made of an acrylic resin, the protection layer 26 may be applied by spin coating, for example, and be photolithographically patterned to cover predetermined areas. Thus, the touch panel 10 shown in FIG. 2 is fabricated.

In the above-described touch panel 10, the second light-shielding layer elements 18 are organic films containing a light-shielding component. As such, the second light-shielding layer elements 18 serve as interlayer insulating films disposed between the layer having the transparent electrodes 16 and the layer having the first relay electrodes 20. The first light-shielding layer element 14 is made of the same material as the second light-shielding layer elements 18. As such, the second light-shielding layer elements 18 may be formed at the same time as the first light-shielding layer element 14. This will reduce the number of steps for manufacturing a touch panel 10.

Further, the touch panel 10 has a smaller number of deposited layers. This will reduce the decrease in the transmittance of the areas of the touch panel 10 where a touch may be detected (specifically, the areas inside the first light-shielding layer element 14).

[Display Device Including Touch Panel]

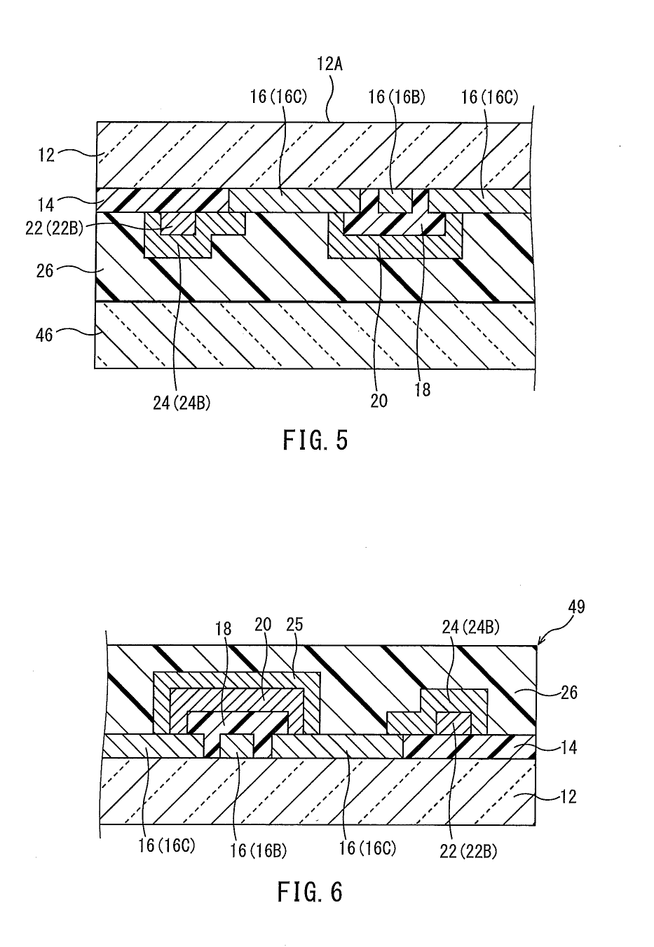

The touch panel 10 may be used in a display device. A display device including the touch panel 10 will be described with reference to FIGS. 4 and 5. FIG. 4 is a schematic view of a display device 40 according to an embodiment of the present invention. FIG. 5 is a cross-sectional view of main elements of the display device 40.

The display device 40 includes the touch panel 10, a liquid crystal panel 42 serving as a display panel, and a backlight 44. In the display device 40, an image displayed on the liquid crystal panel 42 is viewable to a viewer through the input region of the touch panel 10 (more specifically, the region inside the first light-shielding layer element 14). When a finger of the viewer contacts the input region of the touch panel 10, a process corresponding to the touch location is performed on the liquid crystal panel 42.

The liquid crystal panel 42 includes an active-matrix substrate, a counter-substrate, and a liquid crystal layer enclosed between these substrates. The region with a plurality of pixels arranged in a matrix is the display region of the liquid crystal panel 42. In the liquid crystal panel 42, the liquid crystal may have any operating mode. The liquid crystal operating mode may be, for example, TN mode.

The backlight 44 is located adjacent the back side of the liquid crystal panel 42. The backlight 44 may operate in any lighting mode. For example, the backlight 44 may be a direct-lit backlight, or an edge-lit backlight. The backlight 44 may have any light source. The light source of the backlight 44 may be, for example, a cold cathode fluorescent lamp or light-emitting diodes.

The touch panel 10 is located adjacent the front side of the liquid crystal panel 42 (closer to the viewer). As shown in FIG. 5, in the touch panel 10, the protection layer 26 is bonded to the base substrate 46 of the counter-substrate of the liquid crystal panel 42. Here, the substrate 12 located closer to the viewer serves as a cover element. The side 12A of the substrate 12 opposite the side having the first light-shielding layer element 14 formed thereon serves as the touch surface that the finger of the viewer may touch when operating the touch panel 10.

This display device 40 has a reduced thickness since the substrate 12 serves as the cover element.

It is desirable that the width of the second light-shielding layer elements 18 (i.e. its size in the top-to-bottom direction in FIG. 1) be 6 μm or smaller. Thus, the second light-shielding layer elements 18 are less visible.

A second light-shielding layer element 18 hides the portions of a first relay electrode 20 that are not contacted by transparent electrodes 16C. Thus, the first relay electrodes 20 are less visible even when the first relay electrodes 20 are made of metal.

### Example Application 1 of Touch Panel

Example Application 1 of a touch panel according to the first embodiment of the present invention will be described with reference to FIG. 6. FIG. 6 is a cross-sectional view of the touch panel 49 of Example Application 1.

In the touch panel 49, each first relay electrode 20 is covered with an electrode protection film 25. The electrode protection films 25 are formed of the same material as the second relay electrodes 24.

In the touch panel 49, the first relay electrodes 20 and lead lines 22 are formed of the same material.

[Method of Manufacturing Touch Panel]

A method of manufacturing the touch panel 49 will be described below. The method of manufacturing the touch panel 49 includes the step of forming transparent electrodes 16, the step of forming a first light-shielding layer element 14 and second light-shielding layer elements 18, the step of forming first relay electrodes 20 and lead lines 22, the step of forming second relay electrodes 24, and the step of forming a protection layer 26. The step of forming transparent electrodes 16 and the step of forming a first light-shielding layer element 14 and second light-shielding layer elements 18 are the same as in the first embodiment (see FIGS. 3A to 3D), and their description will not be given.

[Step of Forming First Relay Electrodes and Lead Lines]

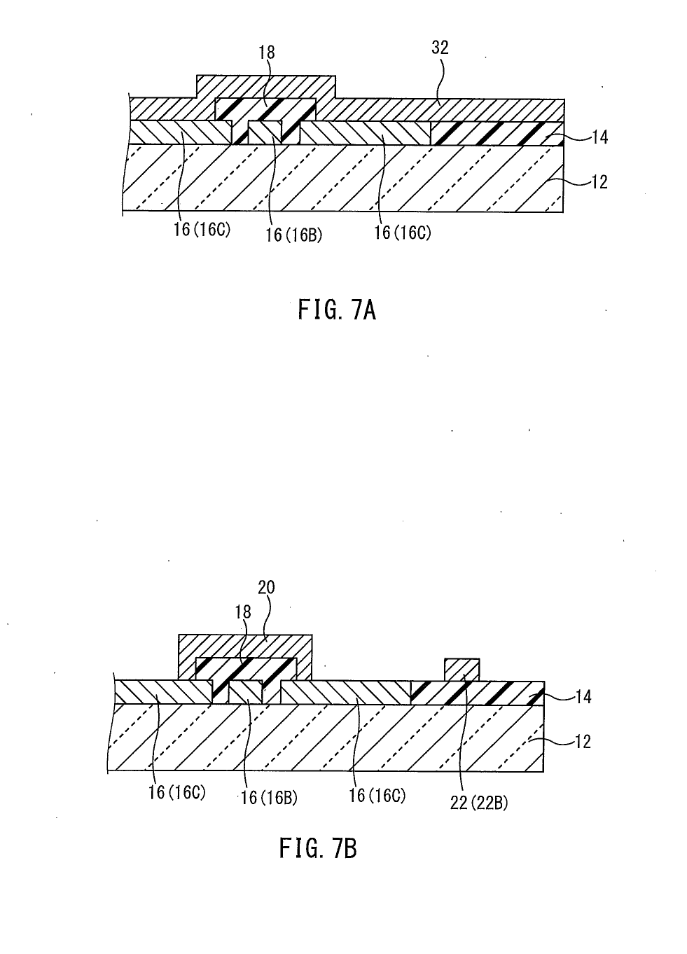

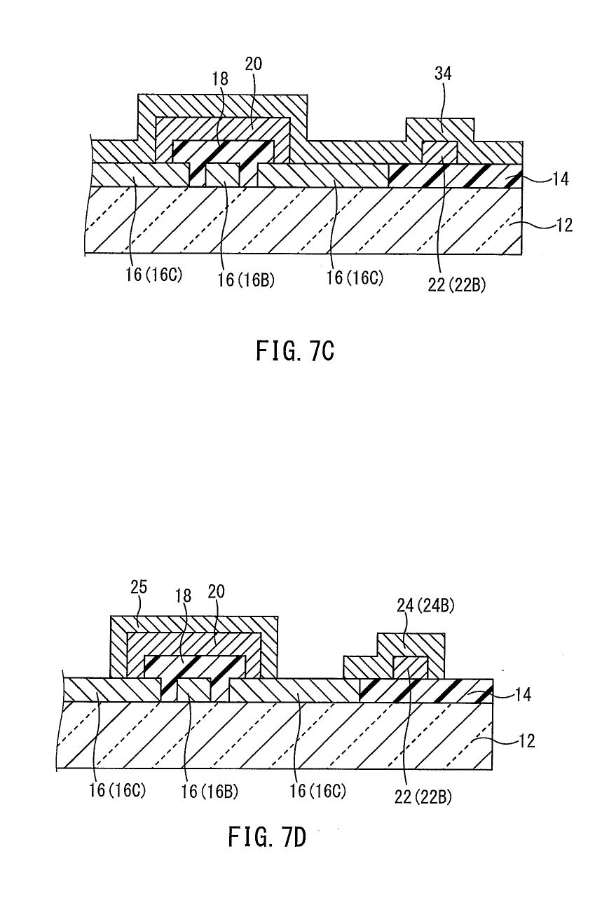

When the first light-shielding layer element 14 and second light-shielding layer elements 18 have been formed as shown in FIG. 3D, first relay electrodes 20 and lead lines 22 are formed. More specifically, first, a metal film 32 is formed as shown in FIG. 7A. The metal film 32 may be formed by sputtering, for example.

Subsequently, the metal film 32 is photolithographically patterned. More specifically, first, a resist in a predetermined pattern is formed on the metal film 32. Then, the portions of the metal film 32 that are not covered with the resist are removed by wet etching. Thereafter, the resist is removed using a stripping agent. Thus, as shown in FIG. 7B, first relay electrodes 20 and lead lines 22 are formed.

[Step of Forming Second Relay Electrodes]

When the first relay electrodes 20 and lead lines 22 have been formed, second relay electrodes 24 are formed. More specifically, first, a transparent conductive film 34 is formed as shown in FIG. 7C.

Subsequently, the transparent conductive film 34 is photolithographically patterned. More specifically, first, a resist in a predetermined pattern is formed on the transparent conductive film 34. Then, the portions of the transparent conductive film 34 that are not covered with the resist are removed by wet etching. Thus, as shown in FIG. 7D, second relay electrodes 24 are formed.

Further, as shown in FIG. 7D, each first relay electrode 20 is covered with an electrode protection film 25. As the first relay electrodes 20 are covered with the electrode protection films 25, they may be prevented from being damaged when the transparent conductive film 34 is patterned.

Furthermore, line protection films 23A cover the respective lead lines 22A, while line protection films 23B cover the respective lead lines 22B. As the lead lines 22A and 22B are covered with the line protection films 23A and 23B, they may be prevented from being damaged when the transparent conductive film 34 is patterned.

[Step of Forming Protection Layer]

When the second relay electrodes 24 have been formed, a protection layer 26 is formed. If the protection layer 26 is to be made of an acrylic resin, the protection layer 26 may be applied by spin coating, for example, and be photolithographically patterned to cover predetermined areas. Thus, the touch panel 49 is fabricated.

### Example Application 2 of Touch Panel

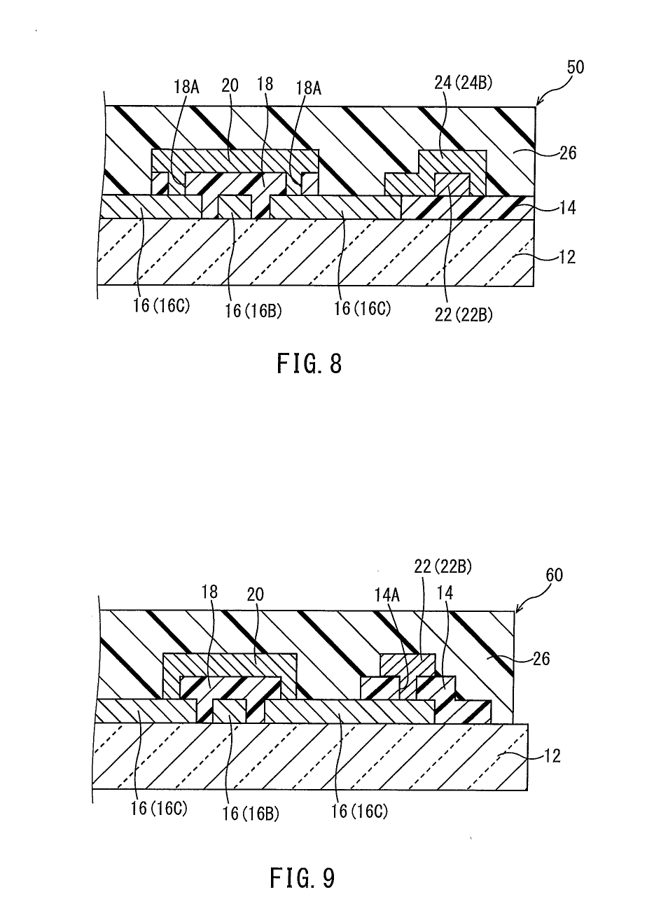

Example Application 2 of a touch panel according to the first embodiment of the present invention will be described with reference to FIG. 8. FIG. 8 is a cross-sectional view of the touch panel 50 of Example Application 2.

In the touch panel 50, contact holes 18A are formed in each second light-shielding layer element 18. The associated first relay electrode 20 contacts the associated third transparent electrodes 16C via the contact holes 18A. The contact holes 18A are formed during the step of forming the first and second light-shielding layer elements 14 and 18.

### Second Embodiment

A touch panel 60 according to a second embodiment of the present invention will be described with reference to FIG. 9. FIG. 9 is a cross-sectional view of the touch panel 60 of the second embodiment of the present invention.

[Overall Construction of Touch Panel]

The touch panel 60 is different from the touch panel 10 in that the first light-shielding layer element 14 overlies that one of the third transparent electrodes 16C in each row extending in the second direction that is located at one end of this row. The first light-shielding layer element 14 includes contact holes 14A. Each contact hole 14A overlies a third transparent electrode 16C in a plan view of the substrate 12. Each lead line 22B contacts a third transparent electrode 16C via a contact hole 14A.

[Method of Manufacturing Touch Panel]

A method of manufacturing the touch panel 60 will be described below. The method of manufacturing the touch panel 60 includes the step of forming transparent electrodes 16, the step of forming a first light-shielding layer element 14 and second light-shielding layer elements 18, the step of forming first relay electrodes 20 and lines 22, and the step of forming a protection layer 26. The step of forming transparent electrodes 16 and the portion of the step of forming first and second light-shielding layer elements 14 and 18 that extends until the formation of the resist 30 are the same as in the first embodiment (see FIG. 3A to 3C), and their description will not be given.

[Step of Forming First and Second Light-Shielding Layer Elements]

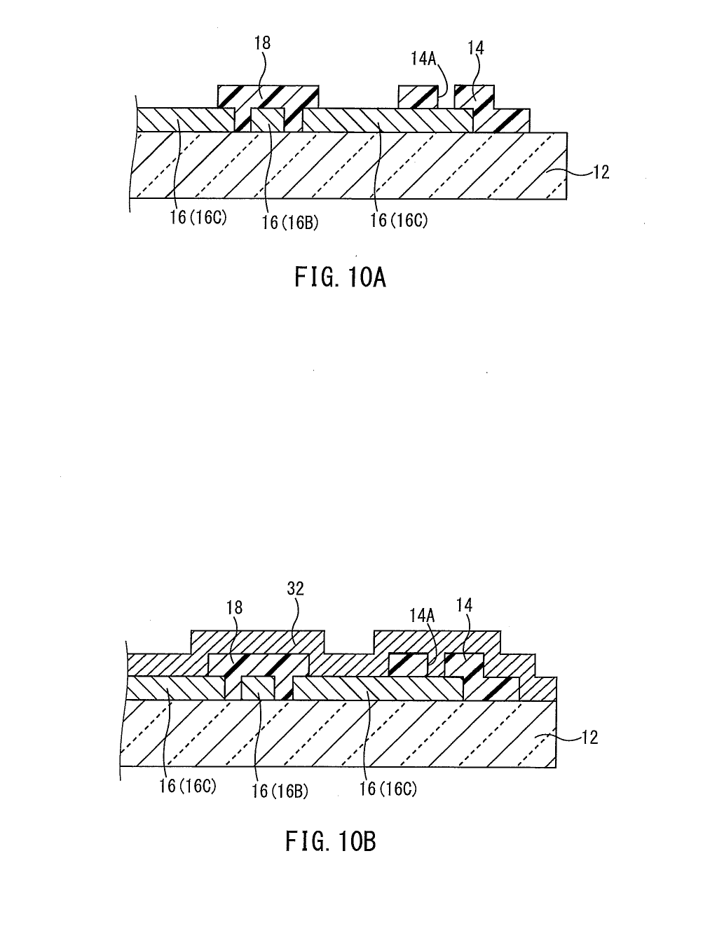

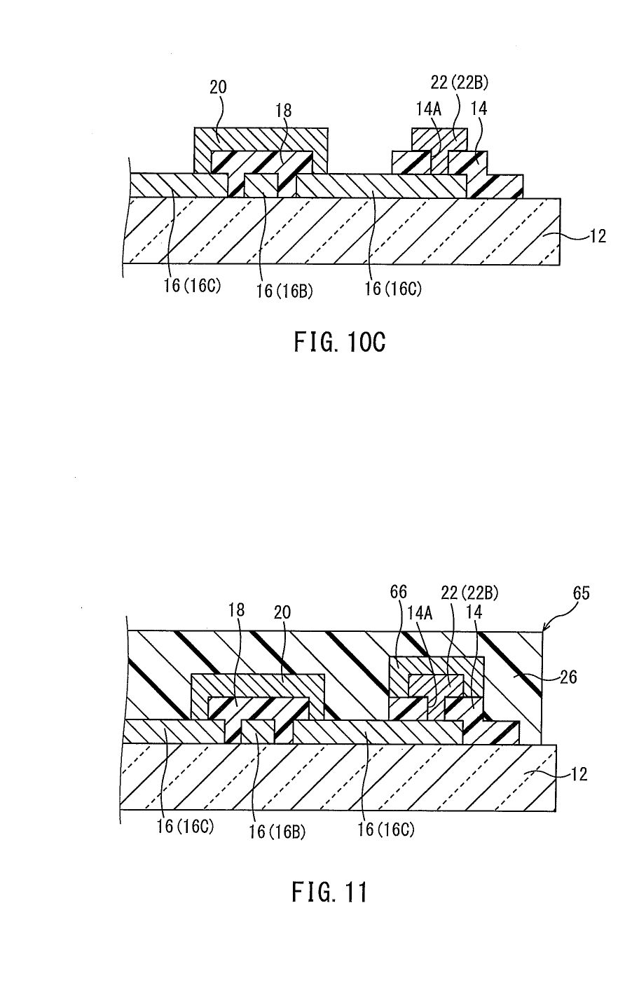

When the resist 30 has been formed as shown in FIG. 3C, the resist 30 is patterned. More specifically, for example, a negative resist 30 may be covered with a mask that is in a predetermined pattern and is then exposed to light before those portions of the resist 30 that have not been exposed to light are removed using a resist stripping agent. Thus, as shown in FIG. 10A, a first light-shielding layer element 14 and second light-shielding layer elements 18 are formed. At this time, contact holes 14A are formed in the first light-shielding layer element 14.

[Step of Forming First Relay Electrodes and Lead Lines]

When the first and second light-shielding layer elements 14 and 18 have been formed, first relay electrodes 20 and lead lines 22 are formed. More specifically, first, a metal film 32 is formed as shown in FIG. 10B. The metal film 32 may be formed by sputtering, for example.

Subsequently, the metal film 32 is photolithographically patterned. More specifically, first, a resist in a predetermined pattern is formed on the metal film 32. Then, the portions of the metal film 32 that are not covered with the resist are removed by wet etching. Thereafter, the resist is removed using a stripping agent. Thus, as shown in FIG. 10C, first relay electrodes 20 and lead lines 22 are formed.

[Step of Forming Protection Layer]

When the first relay electrodes 20 and lead lines 22 have been formed, a protection layer 26 is formed. If the protection layer 26 is to be made of an acrylic resin, the protection layer 26 may be applied by spin coating, for example, and be photolithographically patterned to cover predetermined areas. Thus, the touch panel 60 shown in FIG. 9 is fabricated.

In this touch panel 60, the lead lines 22 and first relay electrodes 20 are formed at the same time. This further reduces the number of steps for manufacturing the touch panel.

Further, in the present embodiment, no line protection film covering a lead line 22 is needed because there is no chance that the lead lines 22 are damaged in the steps following the formation of the lead lines 22.

### Example Application of Touch Panel

An example application of a touch panel according to the second embodiment of the present invention will be described with reference to FIG. 11. FIG. 11 is a cross-sectional view of the touch panel 65 of the example application.

In the touch panel 65, each lead line 22 is covered with a line protection film 66. The line protection films 66 are formed of the same material as the first relay electrodes 20.

[Method of Manufacturing Touch Panel]

A method of manufacturing the touch panel 65 will be described below. The method of manufacturing the touch panel 65 includes the step of forming transparent electrodes 16, the step of forming a first light-shielding layer element 14 and second light-shielding layer elements 18, the step of forming lead lines 22, the step of forming first relay electrodes 20, and the step of forming a protection layer 26. The step of forming a plurality of transparent electrodes 16 and the portion of the step of forming first and second light-shielding layer elements 14 and 18 that extends until the formation of the resist 30 are the same as in the first embodiment (see FIGS. 3A to 3C), and the portion of the step of forming first and second light-shielding layer elements 14 and 18 that follows the formation of the resist 30 and the portion of the step of forming lead lines 22 that extends until the formation of the metal film 32 is the same as in the second embodiment (see FIGS. 10A and 10B), and thus their description will not be given.

[Step of Forming Lead Lines]

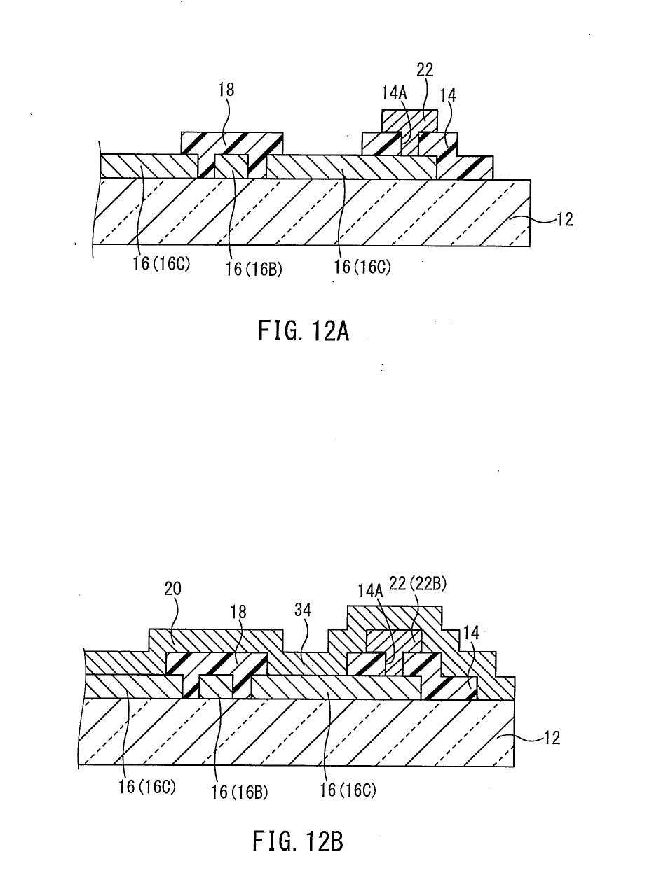

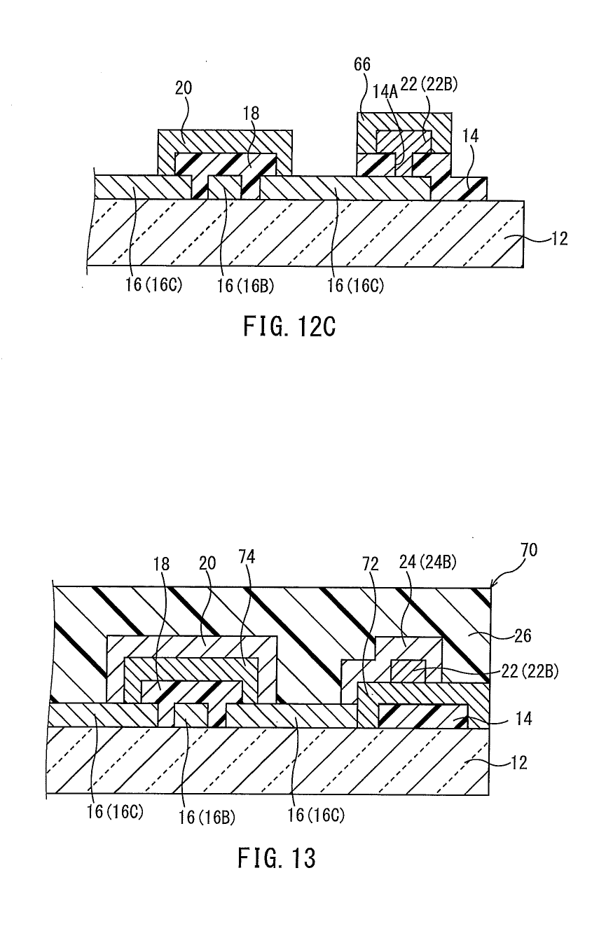

When the metal film 32 has been formed, as shown in FIG. 10B, the metal film 32 is photolithographically patterned. More specifically, first, a resist in a predetermined pattern is formed on the metal film 32. Then, those portions of the metal film 32 that are not covered with the resist are removed by wet etching. Thereafter, the resist is removed using a stripping agent. Thus, as shown in FIG. 12A, lead lines 22 are formed.

[Step of Forming First Relay Electrodes]

When the lead lines 22 have been formed, first relay electrodes 20 are formed. More specifically, first, a transparent conductive film 34 is formed as shown in FIG. 12B.

Subsequently, the transparent conductive film 34 is photolithographically patterned. More specifically, first, a resist in a predetermined pattern is formed on the transparent conductive film 34. Then, the portions of the transparent conductive film 34 that are not covered with the resist are removed by wet etching. Thus, as shown in FIG. 12C, first relay electrodes 20 are formed.

Further, as shown in FIG. 12C, each lead line 22 is covered with a line protection film 66. As the lead lines 22 are covered with the line protection films 66, they may be prevented from being damaged when the transparent conductive film 34 is patterned.

[Step of Forming Protection Layer]

When the first relay electrodes 20 have been formed, a protection layer 26 is formed. If the protection layer 26 is to be made of an acrylic resin, the protection layer 26 may be applied by spin coating, for example, and be photolithographically patterned to cover predetermined areas. Thus, the touch panel 65 shown in FIG. 11 is fabricated.

### Third Embodiment

A touch panel 70 according to a third embodiment of the present invention will be described with reference to FIG. 13. FIG. 13 is a cross-sectional view of the touch panel 70 of the third embodiment of the present invention.

[Overall Construction of Touch Panel]

The touch panel 70 is different from the touch panel 10 in that the first light-shielding layer element 14 is covered with a first protection film 72; lead lines 22B are provided on the first protection film 72; each second light-shielding layer element 18 is covered with a second protection film 74; and a first relay electrode 20 is provided on each second protection film 74. The first and second protection films 72 and 74 may be any insulating film. The first and second protection films 72 and 74 may be, for example, an acrylic resin film, a siloxane-based film, a polyimide-based film or a silicon-based inorganic film.

[Method of Manufacturing Touch Panel]

A method of manufacturing the touch panel 70 will be described below. The method of manufacturing the touch panel 70 includes the step of forming transparent electrodes 16, the step of forming a first light-shielding layer element 14 and second light-shielding layer elements 18, the step of forming a first protection film 72 and second protection films 74, the step of forming lines 22, the step of forming first relay electrodes 20 and second relay electrodes 24, and the step of forming a protection layer 26. The step of forming transparent electrodes 16 and the portion of the step of forming first and second light-shielding layer elements 14 and 18 that extends until the formation of the resist 30 are the same as in the first embodiment (see FIGS. 3A to 3C), and thus their description will not be given.

[Step of Forming First and Second Light-Shielding Layer Elements]

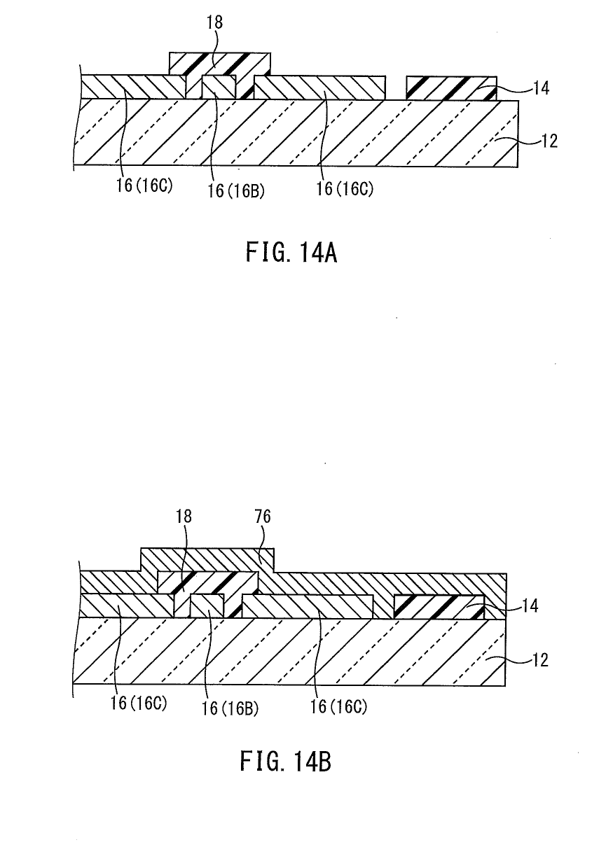

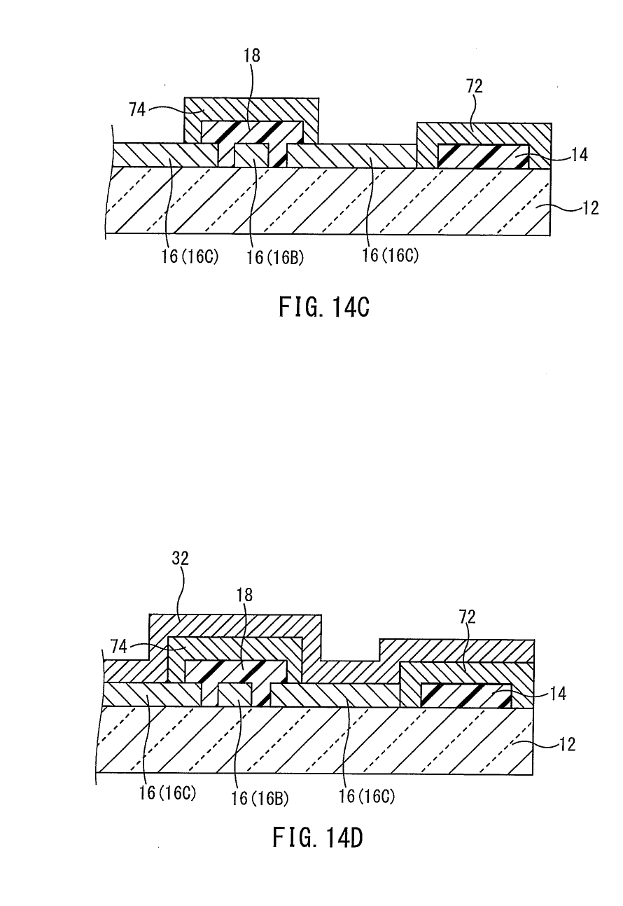

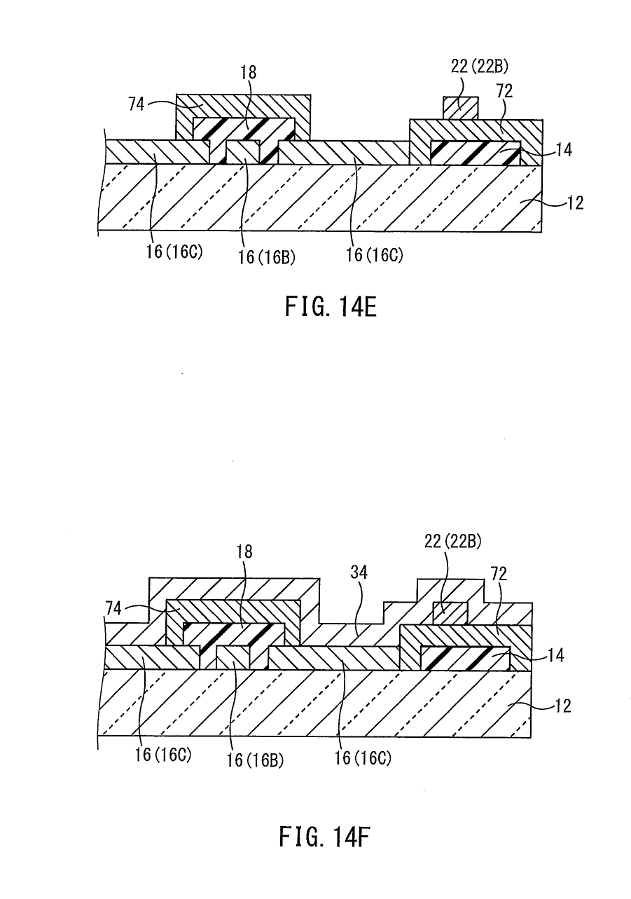

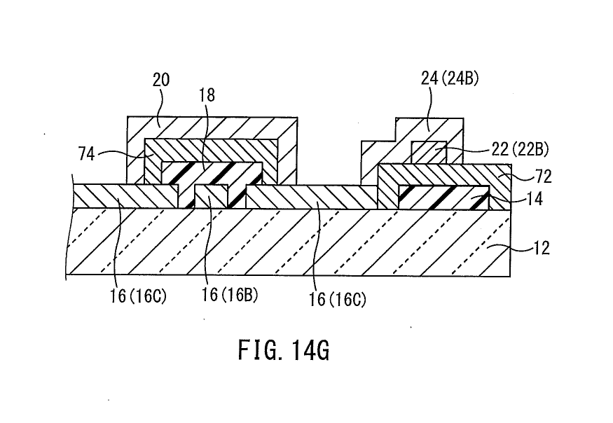

When the resist 30 has been formed as shown in FIG. 3C, the resist 30 is patterned. More specifically, for example, a negative resist 30 is covered with a mask and is then exposed to light. Thereafter, the portions of the resist 30 that have not been exposed to light are removed using a developer. Thus, as shown in FIG. 14A, a first light-shielding layer element 14 and second light-shielding layer elements 18 are formed. Here, a gap is formed between the first light-shielding layer element 14 and that one of the third transparent electrodes 16C in each row extending in the second direction that is located at one end of this row.

[Step of Forming First and Second Protection Films]

When the first and second light-shielding layer elements 14 and 18 have been formed, a first protection film 72 and second protection films 74 are formed. More specifically, first, a protection film 76 is formed as shown in FIG. 14B. If the protection film 76 is a silicon oxide film, the protection film 76 may be formed by chemical vapor deposition (CVD), for example.

Subsequently, the protection film 76 is photolithographically patterned. More specifically, first, a resist in a predetermined pattern is formed on the protection film 76. Then, the portions of the protection film 76 that are not covered with the resist are removed by etching. Thereafter, the resist is removed using a stripping agent. Thus, as shown in FIG. 14C, a first protection film 72 and second protection films 74 are formed.

If the protection film 76 is a silicon oxide film, dry etching is used. It is noted that the first and second light-shielding layer elements 14 and 18 are covered with the protection film 76. Further, the portions of the protection film 76 that contact the first light-shielding layer element 14 and second light-shielding layer elements 18 are covered with the resist. As such, the first and second light-shielding layer elements 14 and 18 are not damaged even if dry etching is used.

Further, as the first protection film 72 covers the first light-shielding layer element 14, the first light-shielding layer element 14 is protected by the first protection film 72 in the subsequent manufacturing steps. As the second protection films 74 cover the second light-shielding layer elements 18, the second light-shielding layer elements 18 are protected by the second protection films 74 in the subsequent steps.

[Step of Forming Lead Lines]

When the first protection film 72 and second protection films 74 have been formed, lead lines 22 are formed. More specifically, first, a metal film 32 is formed as shown in FIG. 14D. The metal film 32 may be formed by sputtering, for example.

Subsequently, the metal film 32 is photolithographically patterned. More specifically, first, a resist in a predetermined pattern is formed on the metal film 32. Then, the portions of the metal film 32 that are not covered with the resist are removed by etching. Thereafter, the resist is removed using a stripping agent. Thus, as shown in FIG. 14E, a plurality of lead lines 22 are formed to contact the surface of the first protection film 72.

The etching of the metal film 32 may be dry etching or wet etching. It is noted that the first light-shielding layer element 14 is covered with the first protection film 72. Further, the second light-shielding layer elements 18 are covered with the second protection films 74. As such, if the first protection film 72 has a sufficient thickness to resist the dry etching, the dry etching will not damage the first light-shielding layer element 14. Similarly, if the second protection films 74 have a sufficient thickness to resist the dry etching, the dry etching will not damage the second light-shielding layer elements 18.

[Step of Forming First and Second Relay Electrodes]

When the lead lines 22 have been formed, first relay electrodes 20 and second relay electrodes 24 are formed. More specifically, first, a transparent conductive film 34 is formed as shown in FIG. 14F.

Subsequently, the transparent conductive film 34 is photolithographically patterned. More specifically, first, a resist in a predetermined pattern is formed on the transparent conductive film 34. Then, the portions of the transparent conductive film 34 that are not covered with the resist are removed by wet etching. Thus, as shown in FIG. 14G, first relay electrodes 20 and second relay electrodes 24 are formed.

[Step of Forming Protection Layer]

When the first and second relay electrodes 20 and 24 have been formed, a protection layer 26 is formed. If the protection layer 26 is to be made of an acrylic resin, the protection layer 26 may be applied by spin coating, for example, and be photolithographically patterned to cover predetermined areas. Thus, the touch panel 80 shown in FIG. 13 is fabricated.

In this touch panel 70, the first light-shielding layer element 14 is protected by the first protection film 72, while the second light-shielding layer elements 18 are protected by the second protection films 74. Thus, during the step of forming the lead lines 22, for example, the first light-shielding layer element 14 and second light-shielding layer elements 18 may be prevented from being damaged when the portions of the metal film 32 that are not covered with the resist are removed by dry etching.

Although embodiments of the present invention have been described in detail, these embodiments are for illustrative purposes only and the present invention is not limited, in any manner, to the above embodiments.

For example, the display panel may be a plasma display panel (PDP), an organic electroluminescent (EL) panel or an inorganic EL panel, for example.

Further, the light-shielding layer need not be in the shape of a picture frame in a plan view of the substrate. For example, in the first embodiment above, the first light-shielding layer element 14 may be present only in the regions where the lead lines 22 are provided.

1. A touch panel comprising:
a substrate;
a series of first electrodes provided on the substrate and arranged in a predetermined direction;
a first light-shielding layer element provided on the substrate and located outside the series of first electrodes measured in the predetermined direction;
second electrodes provided on the substrate, each second electrode located between two first electrodes arranged in the predetermined direction;
second light-shielding layer elements each provided between two first electrodes arranged in the predetermined direction and covering one of the second electrodes;
first relay electrodes each provided above one of the second light-shielding layer elements and electrically connecting two first electrodes arranged in the predetermined direction; and
a metal line provided on the first light-shielding layer element and connected to external circuitry,
wherein the metal line is connected with the one of the series of first electrodes arranged in the predetermined direction that is located at one end of this series,
the side of the substrate that is opposite the side on which the first light-shielding layer element is provided forms a touch surface, and
the first light-shielding layer element and the second light-shielding layer elements are organic films containing a light-shielding component.

2. The touch panel according to claim 1, wherein:
the first light-shielding layer element covers said one of the series of first electrodes arranged in the predetermined direction that is located at one end of this series;
the first light-shielding layer element has a contact hole overlying said one of the first electrodes in a plan view of the substrate; and
the metal line contacts said one of the first electrodes via the contact hole.

3. The touch panel according to claim 2, further comprising: a line protection film covering the metal line,
wherein the line protection film is made of the same material as the first relay electrodes.

4. The touch panel according to claim 1, further comprising: a second relay electrode covering the one of the series of first electrodes arranged in the predetermined direction that is located at one end of this series, and the metal line.

5. The touch panel according to claim 4, further comprising: a line protection film connected with the second relay electrode and covering the metal line.

6. The touch panel according to claim 5, further comprising: electrode protection films covering the respective first relay electrodes,
wherein the first relay electrodes are made of the same material as the metal line, and
the electrode protection films are made of the same material as the second relay electrode.

7. The touch panel according to claim 1, further comprising: a protection film covering the organic films.

8. A display device comprising:
the touch panel according to claim 1, and
a display panel for displaying an image.

9. A method of manufacturing a touch panel comprising the steps of:
forming, on a substrate, a series of first electrodes arranged in a predetermined direction and second electrodes each disposed between two first electrodes arranged in the predetermined direction;
forming an organic film covering the series of first electrodes and the second electrodes;
patterning the organic film to form a first light-shielding layer element located outside the series of first electrodes in the predetermined direction and second light-shielding layer elements each disposed between two first electrodes arranged in the predetermined direction and covering one of the second electrodes;
forming first relay electrodes each located above one of the second light-shielding layer elements and electrically connecting two first electrodes arranged in the predetermined direction; and
forming, on the first light-shielding layer element, a metal line connected to external circuitry,
wherein, in the step of patterning the organic film, the first light-shielding layer element is formed to cover the one of the series of first electrodes arranged in the predetermined direction that is located at one end of this series and a contact hole is formed in the first light-shielding layer element to overlie said one of the first electrodes in a plan view of the substrate, and,
in the step of forming a metal line, the metal line is located to overlie the contact hole in a plan view of the substrate.

10. The method of manufacturing a touch panel according to claim 9, wherein the step of forming first relay electrodes forms the metal line.

11. The method of manufacturing a touch panel according to claim 9, wherein the step of forming first relay electrodes forms a line protection film covering the metal line.

12. A method of manufacturing a touch panel comprising the steps of:
forming, on a substrate, a series of first electrodes arranged in a predetermined direction and second electrodes each disposed between two first electrodes arranged in the predetermined direction;
forming an organic film covering the series of first electrodes and the second electrodes;
patterning the organic film to form a first light-shielding layer element located outside the series of first electrodes in the predetermined direction and second light-shielding layer elements each disposed between two first electrodes arranged in the predetermined direction and covering one of the second electrodes;
forming, on the first light-shielding layer element, a metal line connected to external circuitry;
forming first relay electrodes each located above one of the second light-shielding layer elements and electrically connecting two first electrodes arranged in the predetermined direction; and
forming a second relay electrode covering the one of the series of first electrodes arranged in the predetermined direction that is located at one end of this series, and the metal line.

13. The method of manufacturing a touch panel according to claim 12, wherein the step of forming a metal line forms the first relay electrodes.

14. The method of manufacturing a touch panel according to claim 13, wherein the step of forming a second relay electrode forms a line protection film connected with the second relay electrode and covering the metal line, and electrode protection films covering the respective first relay electrodes.

15. The method of manufacturing a touch panel according to claim 12, wherein the step of forming first relay electrodes forms the second relay electrode.

16. The method of manufacturing a touch panel according to claim 15, wherein the step of forming first relay electrodes forms a line protection film connected with the second relay electrode and covering the metal line.

17. The method of manufacturing a touch panel according to claim 9, further comprising: the step of forming a first protection film covering the first light-shielding layer element and second protection films covering the respective second light-shielding layer elements.
